(19) United States
(12) Patent Application Publication
(10) Pub. No.: US 2002/0188473 A1
(43) Pub. Date: Dec. 12, 2002

(54) Method and system for healthcare management

(76) Inventor: W. Charles Jackson, Pembroke Pines, FL (US)

Correspondence Address: Kevin A. Buford, Esq., Holland & Knight LLP, Suite 700, 1600 Tysons Boulevard, McLean, VA, 22102-4868, US

(21) Appl. No.: 10/166,054

(22) Filed: Jun. 11, 2002

Related U.S. Application Data
(60) Provisional application No. 60/297,658, filed on Jun. 12, 2001.

(51) Int. Cl. G06F 17/60

(52) U.S. Cl. 705/2

(57) ABSTRACT

The present invention addresses many of the issues of the existing healthcare management system by providing each insured with an electronically readable identity card or smartcard 16, which includes a memory device that identifies the insured, the insured's insurance carrier and may include the insured's photograph. The card 16 provides access to a database 22 maintained by the card issuer which includes such records 23 as the insured's current medical history and insurance coverage. Each facility used by an insured will have access to the database 22 for that facility's special needs, i.e., an emergency room would have access to the insured's medical history and drug use but not to financial data. A card reader 13 at each such location has appropriate hardware and software to allow the card reader to access the database and return information to a viewer, such as a computer monitor, to allow the user to view information about the insured.

This is a non-provisional application of U.S. provisional application s/No. 60/297,658 filed on Jun. 12, 2001.

### FIELD OF THE INVENTION

The present invention relates to healthcare management systems and, more particularly, to a method and system for minimizing usage of paper records and improving communication between healthcare providers, insurance providers and pharmacies.

### BACKGROUND

The typical patient seeking medical care on a non-emergency basis first visits a primary care physician (PCP) who performs a first level of screening and evaluation. The PCP may order special tests from outside laboratories, refer the patient to a specialist, issue prescriptions for drugs or direct the patient to a treatment facility such as a hospital. Whatever avenue or avenues is/are selected, each avenue involves the issuance of written documents, such as prescriptions, and often requires that the PCP file requests with the patient's insurance carrier for approval of treatment options. Filing of written requests to the insurance carrier is often tedious and time consuming, particularly in the waiting time to obtain what in some instances may be mere routine approvals, including verifying whether the patient has insurance for the procedure. Further, the patient often misplaces written documents and may have to return to the PCP for replacement instructions or prescriptions. Thus, it would be desirable to provide a system which minimizes written documents and establishes a procedure for more efficient handling of healthcare matters.

### DRAWINGS

The invention may be more readily appreciated from the following detailed description, when read in conjunction with the accompanying drawings, in which:

FIG. 1 illustrates a healthcare management system involving a smart card-enabled access to a medical history and insurance coverage database according to an embodiment of the invention.

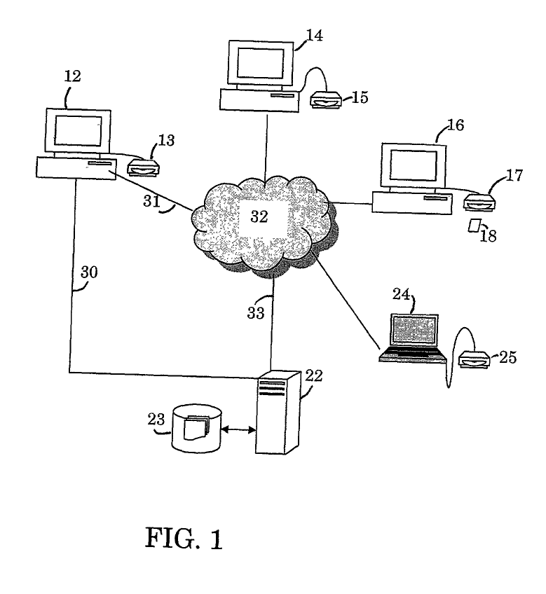

FIG. 2 is a schematic diagram of a healthcare management system illustrating an embodiment of the invention.

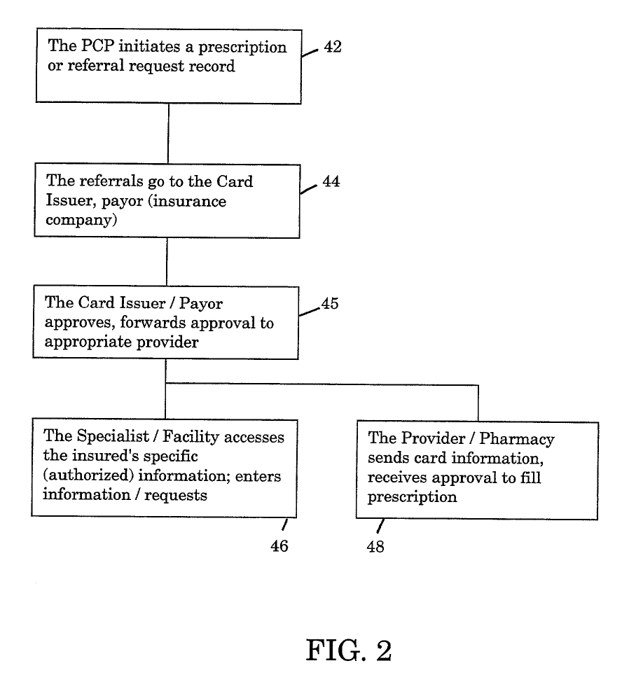

### DETAILED DESCRIPTION

The present invention addresses many of the issues of the existing healthcare management system by providing each insured with an electronically readable identity card 16, sometimes referred to as a smartcard, which includes a memory device that identifies the insured, the insured's insurance carrier and may include the insured's photograph. The card 16 provides access to a database 22 maintained by the card issuer which includes such records 23 as the insured's current medical history and insurance coverage. The insurance coverage information can define the insured's eligibility for emergency room services, in-patient and out-patient treatment, diagnostics, specialist accessibility and prescription drug use and availability. Each facility that may be used by an insured will have access to the database 22 for that facility's special needs, i.e., an emergency room would have access to the insured's medical history and drug use but not to financial data. The card issuer will provide a card reader 13, 15 at each such location with appropriate hardware and software to allow the card reader to access the database and return information to a viewer, such as a computer monitor, to allow the user to view information about the insured.

The card may be used by the PCP to transmit information to the card issuer's system (step 42). The information may include electronic prescriptions that can be automatically approved and transmitted to a pharmacy of the insured's choice. The information may also take the form of requests to approve referral to a specialist or other medical provider. The card issuer may work with the insurance carriers to include guidelines for approval of routine matters, such as prescription drugs or referral to specialists in the carrier's approved list (step 44). In such event, the system can automatically provide approval for the matter and forward the approval to the appropriate provider. For example, if the request is for a specialist consultation, the system can electronically forward the approval to the specialist with instructions to call the insured to set an appointment (step 45). The system can also respond to requests from providers for approval or for identify services to be provided. For example, if the insured chooses a different pharmacy or a pharmacy not on the insured's approved list, the pharmacy can access the system using the insured's identity card 16 and obtain the actual prescription and approval to fill the prescription (step 48). Similarly, the specialist can access the system using the insured's identity card 16 to determine the PCP diagnosis and the tests or treatments requested by the PCP (step 46).

If the insured seeks treatment from a provider (emergency room, pharmacy, etc.,) that is not served by the card issuer and therefore does not have the ability to use the issuer's card swipe technology to access the database system 22, the provider may still obtain limited information by using the internet to access the issuer's web site 23 and using the insured's identifying number on the insured's card 18 to access the specific information for the insured. Certain information normally found on the insured's card such as name, next of kin, date of birth, address, PCP, effective dates and insurance carrier, may be obtained from the web site using the insured's identity number.

As will be appreciated from the above discussion, the invention contemplates two forms of access. The preferable form is via a dedicated computer system using a dial-up access number for point-to-point secure communication. This system incorporates automatic electronic card readers 13, 15 which can read the data stored on the insured's card 16 and may even have the ability to update that information although such updates may be limited to certain selected personnel and require password access to prevent fraud. The reader 13 will provide a view of the stored information through a computer 12 monitor. The computer is part of the system and will include a modem or other device to allow dial-up access 30 to the issuer's system 22, 23. The secondary form of access is via the internet 31-33 and, because it may be less secure than the dial-up connection, will not have the same level of access to patient information as the dial-up connection.

The inventive system provides for a computerized method of electronically transmitted medical information between various healthcare providers in a secure manner. The system also allows the insurance carriers to delegate responsibility for patient tracking and for issuing approvals for routine matters so that the overall healthcare management process is handled more efficiently. Further, the system can represent many different insurance or medical reimbursement providers in a single system so that a patient may change providers without having to drop out of the system. Still further, the patient may keep the same identifier card 16 while changing since only the carrier or provider name may change and that can be updated on the card. Similar changes in PCP can also be accommodated in the same manner. By way of example, one database system 22 can be established to handle patients from the U.S. Armed Services Medical Division, Children and Family Services, State Medicaid Programs, All Insurance Programs, All HMO's, Trade Unions, Foreign Government, Hospitals or other public and private sources of healthcare funding.

The Applicant has conceived a Medical SmartCard reader 13, 15, 25 designed to plug into a PC environment or any newly developed smartcard peripherals for a PC. The reader incorporates a security system comprising a secured line, photo and a Biometric Reader. Approved Biometric authorization by the individual member/patient allows the Provider(s) (Physicians), hospital, diagnostic, ambulance and all medical and related personnel to access all confidential patient information and current medical records.

The electronically readable identity card 16 (“SmartCard”) along with the Biometric Reader 13, 15 will automatically retrieve the patient's information, i.e., photo, insurance carrier and number, name, address and contact information of the patient's next of kin. The Biometric Reader 13, 15 reads the fingerprint or other personal characteristic of the person who presents the SmartCard, allowing the Provider(s) and all pertinent medical personnel access to the most current (real time) medical records 23 and/or any relevant information on the identified person in the hospital emergency room and/or surgical unit.

The Biometric Reader 13, 15 assures a high degree of safety of a patient in a hospital by allowing access to real-time patient information, e.g., at the nurses' station and for distribution of prescription and non-prescriptive drugs and medical treatment.

The Biometric Reader 13, 15 can also be used during patient surgery, both to identify a patient and to assure a proper procedure prior to surgery. For example, a monitor can be installed in each surgical unit that will activate:

1) Photo identification of the patient;

2) Specifically identify the diagnosis;

3) Specifically indicate proposed surgical procedure;

4) Identify all medical instruments and medications to be used during the surgical procedure;

5) Specifically pinpoint procedure for the particular member; and

6) Designed to reduce the risks of mistaken identity, medical errors and incorrect insurance information.

The Biometric Reader 13, 15 can be utilized for all surgical and non-surgical procedures during a patient's stay in a hospital. Upon discharge from the hospital, the Medical SmartCard 16 and the Biometric Reader 13, 15 is designed to automatically close all records for the protection and privacy of the individual patient.

The Biometric Reader 13, 15 can be a Gimp-Touch 440 and/or any other applicable biometric reader device, which positively identifies the user. The Touch-Touch 440 and/or any other applicable biometric reader device is a SmartCard reader with a fingerprint sensor for electronic transaction and logical access control. In the event the user is not capable of using a fingerprint, the user can be issued a unique PIN code. An advantage of the selected reader is the ability to accept all types of ISO7816 compatible microprocessor cards, without any additional development required.

The invention uses a “Dashboard” Application employing Microsoft Digital Dashboard technology to provide a customized portal for all medical related services and medical financial data; along with external information that provides single-click access to collaborative tools.

In the medical industry, different providers of medical services and treatment, allied health professionals, i.e., Primary Care Providers, laboratories, x-ray, pharmacies, hospitals (ER, surgery and surgical units), and all specialties such as orthopedics, psychiatrists, optometrists, neurologists, cardiologists, etc., need access to distinctly different types of medical patient information and to be in compliance with HIPAA rules and regulations. In addition to this, all financial related data, i.e., claims, pharmacy and all medical related financial data on the insured member is accessible to the insurance companies, Medicaid, Medicare, and all other third-party insured. With its flexible, modular architecture, the digital dashboard makes it easy to create personalized applications that meet the needs of users throughout the organization/medical network and insurance industry.

At the heart of the digital dashboard are Web Parts. Web Parts are reusable components that contain Web-based content such as XML, HTML and scripts, and have a set of standards properties that control how the Web Parts are rendered in a digital dashboard. These properties make Web Parts and dashboards storage-neutral and complete reusable.

Because Web Parts adhere to a common standard, we are able to store them in libraries that we can draw from the assemble all digital dashboards in our organization.

The Media Dashboard application runs on a Microsoft Windows 2000 and/or any other applicable software file system, storing Web Parts and digital dashboards and/or applicable software in the server. These components are stored in folders that have a special set of WebTV properties identifying them as Web Parts and digital dashboard or any applicable software folders.

What is described is a patient ID system using SmartCard technology that is integrated into a medical support system allowing all levels of medical personnel to access a user's medical records and to service the needs of the user without extensive paper trails. The system provides accurate and up-to-date patient records and allows fulfillment of patient needs, such a prescriptions, without having the prescriptions issued in paper form. Further, the system allows the healthcare providers to rapidly process and approve payments for medical services using electronic, i.e., internet or direct dial-up service communication.

While the foregoing constitute certain preferred and alternative embodiments of the present invention, it is to be understood that the invention is not limited thereto and that in light of the present disclosure, various other embodiments will be apparent to persons skilled in the art. Accordingly, it is to be recognized that changes can be made without departing from the scope of the invention as particularly pointed out and distinctly claimed in the appended claims which shall be construed to encompass all legal equivalents thereof.

What is claimed is:

1. A method for healthcare management comprising:
issuing to each insured an electronic identity card containing sufficient information to identify the insured;
providing a database containing personal, medical and healthcare funding information for each insured;
providing a means for secure access of the database using information from the identity card;
enabling each healthcare provider to electronically access the database to update information therein and to transmit information to enable the insured to obtain healthcare from multiple, independent healthcare providers.

2. The method of claim 1 wherein the healthcare providers include pharmacies for dispensing prescription medicines and the prescriptions for such medicines are electronically transmitted from the prescribing provider to the pharmacies, and the means for secure access is further responsive to allow access based upon unique PIN code.

3. The method of claim 2 wherein the prescriptions are transmitted through a system containing the database and the method includes obtaining pre-approval of funding of the prescription medicines at the database system.

4. The method of claim 1 wherein the healthcare providers include specialists and facilities for providing healthcare services and, after the card is used to verify the identity of the patient, the system provides a requesting specialist with identification of the approved services to be provided.

5. The method of claim 4, wherein the identification of approved services comprises identifying the diagnosis, procedure and medical instruments and medications indicated.

6. The method of claim 1 wherein the identity card is a smart card that together with a biometric reader identifies the insured using biometric information, and wherein the step of enabling each healthcare provider to electronically access the database comprises providing access to different types of patient information based on the specialty of the requesting healthcare provider.

7. A system for healthcare management comprising:
an identity card reader capable of reading secure information on an identity card for a patient;
a healthcare provider computer operably coupled to the reader capable of receiving patient identifying information from the reader;
a medical database system operably coupled to the healthcare provider computer capable of receiving the patient identifying information, further provider information and patient medical information, and returning, based on the patient identifying information and further provider information, approved patient information to the healthcare provider computer;
a further healthcare provider computers operably coupled to the medical database system, wherein the medical database system is operable to forward approval information for medical services for the patient to at least one of the further healthcare provider computers based on the patient medical information from the healthcare provider computer.

8. The system of claim 7 wherein identity card comprises a memory capable of updatably storing current medical payor information for the patient, and wherein the medical database system is operable to provide approval information based on insurance coverage information from the current medical payor.

9. The system of claim 7 wherein the medical database system comprises a digital dashboard system that provides different types of patient medical and financial information as the approved patient information to different types of healthcare providers based on access need.

10. A system for flexible healthcare management comprising:
a medical database system having patient medical and financial information for patients, and coverage information from plural insurance companies;
healthcare provider systems operably coupled to the medical database system comprising computers and card readers each capable of reading secure information from a medical smart card uniquely identifying a single patient;
wherein the medical database system is configured to provide selective medical information about said single patient based on a requesting first healthcare provider information and patient identifying information from a card reader, and to forward approved medical information to another healthcare provider based on services provided by the first healthcare provider.
